(19) United States
(12) Patent Application Publication
(10) Pub. No.: US 2007/0091520 A1
(43) Pub. Date: Apr. 26, 2007

(54) GROUND FAULT CIRCUIT INTERRUPTER HAVING AN INTEGRATED VARIABLE TIMER

(76) Inventors: Mario Angelides, Rockville Centre, NY (US); Roger M. Bradley, North Bellmore, NY (US); Benjamin Moadel, New York, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/535,892

(22) Filed: Sep. 27, 2006

Related U.S. Application Data
(60) Provisional application No. 60/721,400, filed on Sep. 28, 2005.

(51) Int. Cl. H02H 3/00

(52) U.S. Cl. 361/42

(57) ABSTRACT

A circuit interrupter having an integrated variable timer circuit for alerting an end-user of an impending test of the circuit interrupter which expands the function of a basic circuit interrupter by adding visual/audible warning indicators and the capability of the circuit interrupter to test itself is described herein. The integrated variable timer circuit includes a variable resistor where the user can adjust the current flowing to a capacitor. The variable resistor enables the ability for the user to adjust the predetermined testing time. When the charge across the capacitor surpasses the voltage of a parallel, connected Zener diode, a transistor turns on a self-test subcircuit or visual/audible warning indicator. A switch across capacitor is used to discharge the capacitor and to reset the timer. A switch is included to enable a manual trip after the self test has completed.

This application claims priority pursuant to 35 U.S.C. 119(e) from U.S. Provisional Patent Application having application No. 60/721,400 filed Sep. 28, 2005.

### FIELD OF THE INVENTION

The present invention relates to a ground fault circuit interrupter and, more particularly, to a ground fault circuit interrupter having improved functions.

### BACKGROUND OF THE INVENTION

Circuit breaking devices or systems are designed to interrupt power to various loads, such as household appliances, consumer electrical products and branch circuits in an effort, for example, to protect from electrical shock. Specifically, a common 120V electrical receptacle in the United States has two vertical slots (neutral and hot) and a semi-circular slot (ground) centered beneath the two. When an appliance is working properly, all current that the appliance uses flows from hot to neutral. Yet, in the case when, for example, a person uses an appliance in the rain, an extra path exists from the hot wire inside the appliance through the water and the person to ground. Thereby, an imbalance in the current that flows from hot to neutral is generated. A circuit breaking device, such as a ground fault circuit interrupter (GFCI) device senses this current imbalance which partially flows through the person and partially through the hot to neutral. As a result, when a current imbalance exists, the GFCI trips the circuit and disconnects the power supplied to the circuit. Conventionally, a GFCI will be able to sense a mismatch as small as 4 or 5 milliamps, and can react as quickly as one-thirtieth of a second.

An increased demand for these circuit breaking devices presently exists since electrical codes in many states require that electrical circuits in residential and commercial bathrooms and kitchens be equipped with ground fault circuit interrupters. Presently available circuit interrupter devices, such as the device described in commonly owned U.S. Pat. No. 4,595,894, use a trip mechanism to mechanically break an electrical connection between one or more input and output conductors. Such devices are resettable after they are tripped after the detection of a ground fault, for example. In the device discussed in the '894 patent, the trip mechanism used to cause the mechanical breaking of the circuit (i.e., the connection between input and output conductors) includes a solenoid (or trip coil). A test button is used to test the trip mechanism and circuitry used to sense faults and a reset button is used to reset the electrical connection between input and output conductors.

This test button, however, is manual and is not automatic. Accordingly, there are times when a user may not remember to test the system for months. In addition, there is no visual or audible notification of whether the system has been tested.

The present invention is directed to overcoming, or at least reducing the effects of one or more of the problems set forth above.

### SUMMARY OF THE INVENTION

To address the above-discussed deficiencies of a ground fault circuit interrupter (GFCI), the present invention discloses a GFCI having an integrated variable timer circuit that may be used to alert a user of an impending test. In the alternative, the integrated variable timer circuit may be used to alert a self-test circuit. The integrated variable timer circuit includes a resistive/capacitive (RC) timing circuit which may trigger a light emitting diode (LED) indicator or other suitable indicator to alert the end-user of the time to conduct the periodic monthly test. The resistive part of the RC circuit includes a variable resistor which can be adjusted by the user to vary the amount of time between tests when the indicator will be activated. Thus, the testing time is not limited to a monthly test (i.e.—the periodic test may be stipulated in terms of days, weeks, months, etc.). Instead of activating the LED, the output of the integrated variable timer circuit may activate a simulated ground fault resistor. The simulated ground fault trips the GFCI automatically and forces the user to perform a test of the unit.

Alternatively, the output of the integrated variable timer circuit described above may drive other circuitry to automatically test and reset the GFCI on a periodic basis (as described above) without any intervention from the user.

The GFCI of the present invention comprising an integrated variable timer allows the user to adjust how frequently an alert is indicated or a self-test is conducted. In addition, this circuit interrupter allows the user to input time for any self test or indication.

Specifically, the integrated variable timer circuit includes a diode connected between the phase lead of the face terminal and a variable resistor. A capacitor is placed between the variable resistor and the neutral lead of the face terminal. A series connected Zener diode and resistor is placed between the variable resistor and the base of a transistor. One end of the variable resistor forms a first node for an indicator or a self test signal. A second node for the indicator or the self-test signal is formed by the collector of the transistor.

Advantages of this design include but are not limited to a GFCI with the capability to efficiently monitor and warn the user of pending test dates or test cycles. Moreover, this GFCI indicates visually and/or audibly when the GFCI should be tested.

These and other features and advantages of the present invention will be understood upon consideration of the following detailed description of the invention and the accompanying drawings.

### BRIEF DESCRIPTION OF THE DRAWINGS

For a more complete understanding of the present invention and the advantages thereof, reference is now made to the following description taken in conjunction with the accompanying drawing in which like reference numbers indicate like features and wherein:

FIG. 1 illustrates the schematic for a sensing circuit having an integrated variable timer circuit in accordance with the present invention;

FIG. 2 displays the schematic for the integrated variable timer circuit shown in FIG. 1 in accordance with the present invention;

FIG. 3 shows the schematic for a sensing circuit of FIG. 1 having an integrated variable timer circuit with a visual indicator in accordance with the present invention; and

FIG. 4 illustrates the schematic for a sensing circuit of FIG. 1 having an integrated variable timer circuit with an automatic fault generator in accordance with the present invention.

### DETAILED DESCRIPTION OF PREFERRED EMBODIMENTS

The present invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The present invention contemplates various types of circuit interrupting devices that have at least one conductive path. The conductive path is typically divided between a line side that connects to electrical power, a load side that connects to one or more loads and a user side that connects to user accessible plugs or receptacles. The various devices in the family of resettable circuit interrupting devices comprise: ground fault circuit interrupters (GFCI's), arc fault circuit interrupters (AFCI's), immersion detection circuit interrupters (IDCI's), appliance leakage circuit interrupters (ALCI's) and equipment leakage circuit interrupters (ELCI's).

For the purpose of the present application, the structure or mechanisms used in the circuit interrupting devices, shown in the drawings and described herein below, are incorporated into a GFCI device suitable for installation in a single-gang junction box used in, for example, a residential electrical wiring system. However, the mechanisms according to the present application can be included in any of the various devices in the family of resettable circuit interrupting devices.

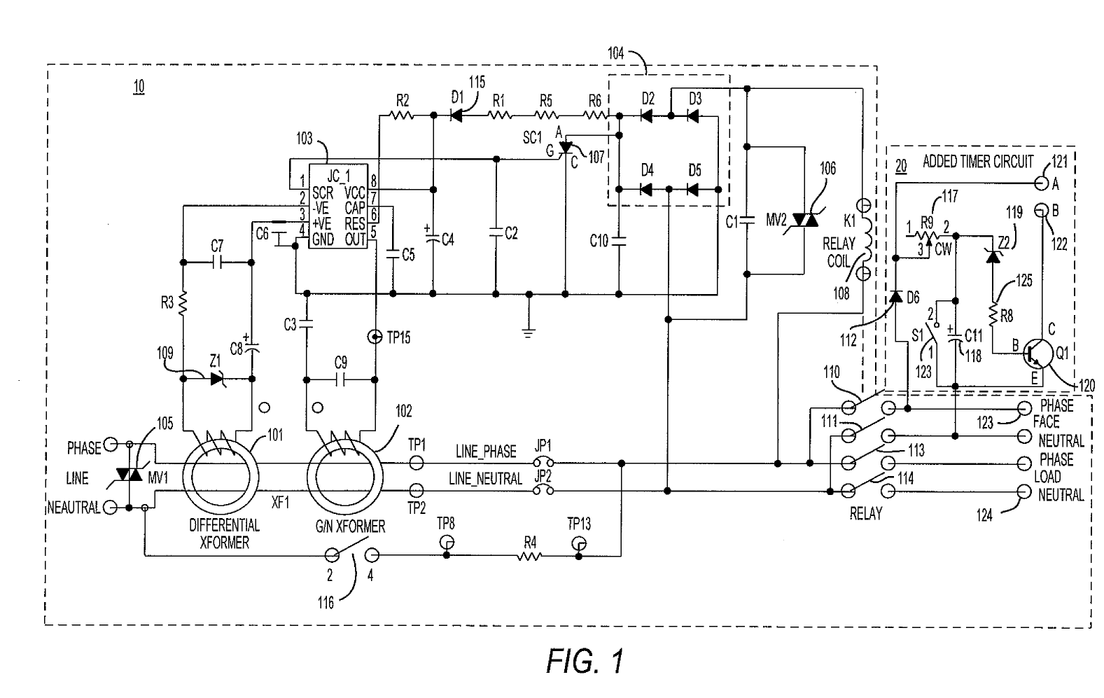

The present invention includes a known sensing circuit. Hence, this detailed description begins with a discussion of the sensing circuit portion 10 shown in FIG. 1. The illustrated sensing circuit comprises a differential transformer 101, a Ground/Neutral (G/N) transformer 102, an integrated circuit 113 for detecting current and outputting a voltage once it detects a current, a full wave bridge rectifier 104, a first and second surge suppressor 105 and 106 for absorbing extreme electrical energy levels that may be present at the line terminals, various filtering coupling capacitors (C₂-C₁₀), a gated semiconductor device 107, a relay coil assembly 108, various current limiting resistors (R₁—R₆) and a voltage limiting Zener diode 109. The mechanical switch 116 is shown connected to the conductors of the line terminals. Movable bridges 110, 111, 113 and 114 are shown as switches that connect the line terminals to the face 123 and load 124 terminals. The line, load and face terminals are electrically isolated from each other unless connected by the movable bridges 110, 111, 113 and 114.

When a predetermined condition—such as a ground fault—occurs, there is a difference in current amplitude between the two line terminals. This current difference is manifested as a net current which is detected by the differential transformer and is provided to integrated circuit 103. Integrated circuit 103 can be any one of integrated circuits typically used in ground fault circuits (e.g., LM-1851) manufactured by National Semiconductor or other well known semiconductor manufacturers. In response to the current provided by the differential transformer, integrated circuit 103 generates a voltage on pin 1 which is connected to the gate of gated semiconductor device 107. Device 107 can be any type of gated semiconductor device that acts as a switch. As shown, device 107 is implemented as a silicon controlled rectifier (SCR). A full wave bridge comprising diodes 104 has a DC side which is connected to the anode of gated semiconductor device 107. When a proper gating signal is applied to the gate of device 107, device 107 is turned on shorting the DC side of the full wave bridge activating relay 108 which causes the movable bridges to remove power from the face and load terminals. The relay 108 may be implemented using a bobbin, coil and plunger components, as shown. Diode 115 performs a rectification function retaining the supply voltage to integrated circuit 103 when device 107 is turned on. The relay 108 can also be activated when mechanical switch 116 is closed which causes a current imbalance on the line terminal conductors that is detected by the differential transformer. The transformer 102 detects a remote ground voltage that may be present on one of the load terminal conductors and provides a current to integrated circuit 103 upon detection of this remote ground which again activates relay 108.

The sensing circuit 10 engages a latching mechanism of the circuit interrupting device causing the device to be tripped. Also, the sensing circuit allows the GFCI device to be reset after it has been tripped if a reset lockout has not been activated. In the tripped condition the line terminals, load terminals and face terminals are electrically isolated from each other. Thus, even if the device is reverse wired, there will be no power at the face terminals. A circuit interrupting portion may comprise a coil and plunger assembly, the latch plate and lifter assembly (not shown) and the mechanical switch assembly 116.

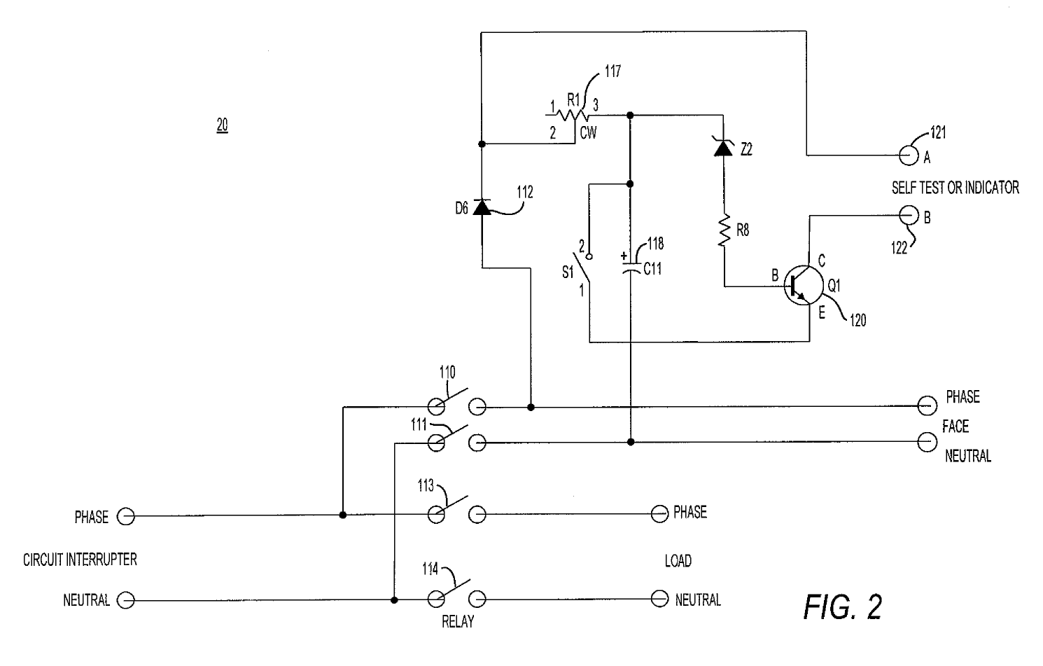

Referring to FIGS. 1 and 2, the integrated variable timer circuit 20 enables the user to adjust the time period between test initiations of the GFCI. The user has the option of setting the predetermined testing time to any amount of time. For example, the user may set the predetermined testing time to test every 30 days or even weekly (every 7 days). Once the self-trip circuit 20 is programmed, the integrated variable timer circuit 20 tracks the amount of time lapsed between a previous test button initiation and the present date. In one embodiment, if the time set has lapsed or expired, the integrated variable timer circuit 20 will notify the user with an audible sound. In the alternative, the integrated variable timer circuit 20 will notify the user with a visual signal.

The ability to adjust the predetermined testing time is made possible through the use of a variable resistor 117 where the user can adjust the current flowing to the capacitor 118. As shown, diode 112 connects the phase lead of the face terminal and the variable resistor 117. Capacitor 118 connects the neutral lead of the face terminal and the variable resistor 117. Zener diode 119 is connected in series with resistor 125 between the base of transistor 120 and variable resistor 117. When the charge across the capacitor surpasses the voltage of the Zener diode 119, the transistor 120 turns on another test circuit or indicator (not shown) across nodes 121 and 122. A manual switch 123 connected across capacitor 118 is used to discharge the capacitor and reset the timer. This switch 123 may be closed to enable a manual trip or after a self-test has completed. Another test circuit or indicator may connect across nodes 121 and 122 to implement some other self test technique.

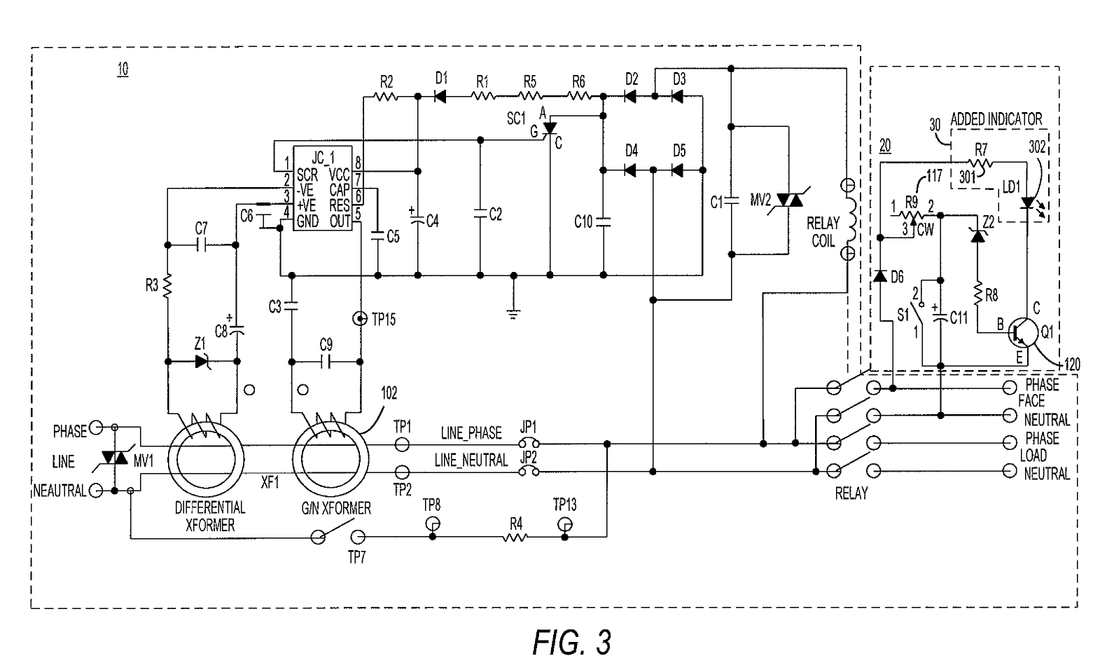

The integrated variable timer circuit 20 may be used as mentioned previously to alert the user of a pending date or a past date using either a visual or an audible alert signal. FIG. 3 illustrates the sensing circuit portion 10 and the integrated variable timer circuit 20 with an added indicator circuit 30 as shown. In particular, resistor 301 and a light emitting diode LD₁ are connected in series across the self-test circuit 20. Resistor 301 connects to the variable resistor 117 while light emitting diode 302 connects to the collector of transistor 120.

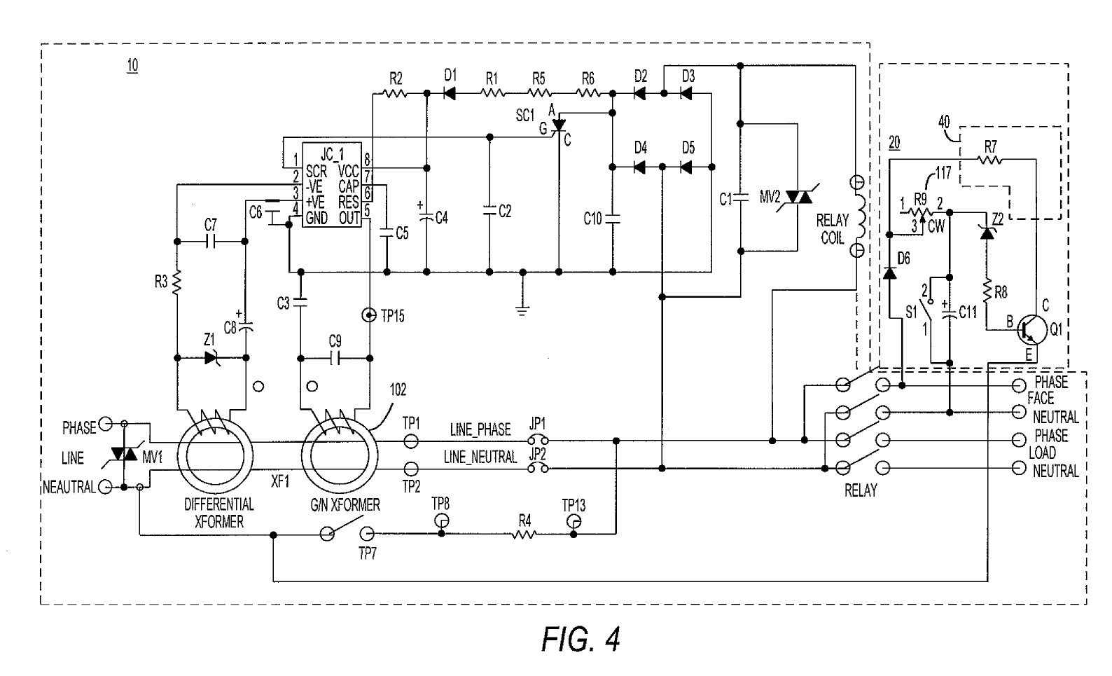

In another embodiment, the variable timer circuit 20 is connected to a self-test circuitry to automatically test the GFCI upon reaching some predetermined testing time set by the user. FIG. 4 shows this embodiment which includes the sensing circuit 10 and the integrated variable timer circuit 20 connected to a self-test sub-circuit portion 40. Those skilled in the art would recognize that the self-test sub-circuit portion 40 is one example of a self-test circuitry. Therefore, the self test sub-circuit may be replaced by an alternative one that enables the GFCI to perform the same function. This sub-circuit portion 40 includes resistor 301 which is used to provide the automatic self-test feature. As shown, resistor 301 connects in parallel across series connected variable resistor 117 and transistor 120. Specifically resistor 301 is connected to the collector of transistor Q₁ and connected to the variable resistor 117. A voltage drop across resistor 301 simulates a ground fault which causes the GFCI to break the electrical connection of the circuit which the GFCI is protecting. In this embodiment, the user is enabled to set the predetermined testing time and the GFCI will test itself within every set testing time period.

Advantages of this design include but are not limited to a circuit interrupter having an alerting or a self-testing feature that enables high performance. This circuit interrupter design is both simple and cost effective.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A fault circuit interrupter for use with an alternating current (AC) receptacle, having at least one source terminal and at least one load terminal, the fault circuit interrupter comprising:
a fault detection circuit adapted to enter a fault state in response to an imbalance of current flow in the AC receptacle and to generate a signal indicative of a fault responsive to the imbalance of current flow;
a trip mechanism in operable communication with the fault detection circuitry such that in response to the signal the trip mechanism is caused to break the conductive path between the source and load terminals of the AC receptacle;
a test switch which creates generation of the imbalance of current flow indicative of a ground fault; and
a integrated variable timer circuit for tracking the time between each actuation of the test switch within a given predetermined time period and generating a test-initiate signal at the end of the predetermined time period.
